(19) United States
(12) Patent Application Publication
(10) Pub. No.: US 2007/0109405 A1
(43) Pub. Date: May 17, 2007

(54) Method of digital exposure modification of images

(76) Inventor: Thierry Prigent, Saint-Helene (FR)

Correspondence Address: PATENT LEGAL STAFF, EASTMAN KODAK COMPANY, 343 STATE STREET, ROCHESTER, NY, 14650-2201, US

(21) Appl. No.: 10/565,862

(22) PCT Filed: Jul. 10, 2004
(86) PCT No.: PCT/EP04/07621

§ 371 Date: Jan. 24, 2006

(30) Foreign Application Priority Data
Jul. 25, 2003 (FR) 03/09097

(51) Int. Cl. H04N 5/253

(52) U.S. Cl. 348/96

(57) ABSTRACT

A method of digital exposure modification of shot images of a photographic support (10) comprising the shot images (12) and at least one sensitometry control (16), includes the digitization (20), in more or less the same conditions, of the images and the sensitometry control, in order to link at least one digital code to the image pixels and the sensitometry control pixels; the establishment of at least one sensitometry relationship (22) from the various exposure values of the sensitometry control and the digital codes linked to the pixels corresponding to these values; the shift of at least one part of the digital codes of the image pixels, each code being shifted by a value established according to a required modification amplitude of the exposure and, with respect for the sensitometry relationship.

### FIELD OF THE INVENTION

The present invention relates to a method of digital exposure modification of shot images. Exposure modification means a correction or compensation of the image exposure. This can affect the image either all together or in some of its colors only. Exposure modification is an a posteriori modification, i.e. a modification made after the shooting. It consists in simulating the density of the image or the density of at least one of the colored components as they would have been obtained with a different exposure. The invention also relates to an image shooting method including a digital exposure modification step.

A posteriori exposure modification can result from technical choices or artistic choices.

From an artistic viewpoint, a first cameraman or a photographer can decide to over-expose or under-expose a film in order to increase or on the contrary to reduce the apparent grain of the images. They can also decide to use shifts of color or color temperature to give images a special “atmosphere”. Color and exposure shifts, for instance, enable nighttime recording conditions to be simulated for scenes shot in the daytime.

A posteriori exposure modification can also be for simply technical reasons. Indeed, the possibility of correcting exposure a posteriori enables the almost indifferent use of Day Light or Tungsten type films when shooting.

The invention can have applications in various fields of shooting on film, and in particular in motion picture and cinema fields.

### BACKGROUND OF THE INVENTION

A silver film, such as a cinema film, for instance, is essentially characterized by its sensitometry curve. The sensitometry curve demonstrates the film's response to the exposure light impacting it. More precisely it links the light energies received by the film to the density values resulting from chemical processing of the film.

The sensitometry curve that may be established for each of the film's primary colors, is valuable data for adjusting cameras, but also for adjusting the processing parameters that occur after the shooting, such as, for instance, development. These parameter adjustments are generally performed with reference to standard sensitometry curves.

Indeed, film manufacturers generally provide users with the standard sensitometry curves for each film type. These standard curves reflect the film's behavior as it is for marketing purposes, and subject to reference chemical processing.

However, the film's response to light is not stable over time. It is liable to be modified especially with the aging of the film and the thermal stresses suffered by the film. The chemical processing the film has been subject to, such as development, also affects its density in response to a received light exposure.

A film sensitometry curve can be reconstituted by taking care first to form a sensitometry control on part of the film. The control has several ranges that have received different exposure energies. These are known exposure energies or at least exposure energies whose value or graduation can be established by calculation. The sensitometry control is preferably formed when shooting. Indeed, the part of the film bearing the sensitometry control undergoes the same stresses, the same aging and the same chemical processing as the rest of the film. Thus it enables changes of its characteristics to be taken into account faithfully.

There is another difficulty when a film is digitized. This is linked to the scanner's more or less good reliability, to its more or less accurate calibration, and to the digital processing chain. It can also be useful to take a sensitometry control into account. For illustration, document (1) can be referred to whose exact reference is given at the end of the present description.

Document (1) relates to the capture of digital values and their processing in order to correspond as accurately as possible to the filmed scene.

### SUMMARY OF THE INVENTION

The invention does not target the capture of digital values but their modification in order to simulate special shooting conditions, which amounts to the a posteriori modification of the exposure conditions. The processing used on the digital values, still called digital codes, consists in replacing these codes by codes corresponding to a greater or lesser exposure. It can be performed on all the color components or on only part of the color components, and enable the image rendering to be changed to a large extent. However, it is observed that the modification of digital codes often affects the images' natural character.

It is the object of the invention to propose a method of digital modification of image exposure that does not have the above-mentioned difficulties.

In particular one object is to enable exposure modification for one or more color components that does not affect the images' natural character.

Yet another object is to facilitate the digital processing of images by reducing the control parameters made available to the user.

To achieve these objects, the invention more precisely relates to a method of digital exposure modification of the shot images of a photographic support comprising the shot images and at least one sensitometry control corresponding to many exposure values, the method comprising the following steps:
a) the digitization, substantially the same conditions, of the images and the sensitometry control, in order to link at least one digital code to the image and sensitometry control pixels,
b) the establishment of at least one sensitometry relationship from the various exposure values of the sensitometry control and the digital codes linked to the pixels corresponding to these values,
c) the shift of at least one part of the digital codes of the image pixels, each code being shifted by a value established according to required a modification amplitude of the exposure, with respect for the sensitometry relationship previously established.

The number of pixels and codes taken into account for each image is mainly dictated by the resolution of the required digital image.

Digitization of the images and the sensitometry control is performed more or less in the same conditions. Preferably the same scanner is used, with the same adjustments, to digitize the images and the sensitometry control. This precaution does not enable the faithfulness of the digital data in relation to the captured images to be guaranteed, but it ensures consistency between the data coming from the sensitometry control and the images. In other words, an identical digital code is linked to a pixel taken in the same density ranges of the sensitometry control or an image.

The establishment of the sensitometry relationship in a sense means establishing a sensitometry curve. However, unlike a conventional sensitometry curve, the sensitometry relationship does not link the exposure energies to the optical densities but to the digital codes. The sensitometry relationship therefore does not represent just the behavior of the developed film but also includes the scanners. The sensitometry relationship can be established, for instance, as a table of values that links the exposure energies of the sensitometry control to the digital codes. Naturally the table can contain additional interpolation values, so that one exposure energy corresponds to each digital code for a given range.

As mentioned in the introduction, exposure modification is a posteriori modification. The user chooses the amplitude of the modification or the compensation that he/she wishes to use. It can be a single value for one or more images. Several different compensation values can also be retained for different color components of the images (red, green blue or magenta, cyan, yellow). The values can be chosen for all the image, or possibly for part of the image.

As required, the method can be applied to all or part of the digital codes of all or part of the image. Modification of the codes can be performed for many film images, for instance, for all the images of a sequence. Modification can also vary for images of the same sequence in order to obtain an artistic effect.

The amplitude of the required modification is not represented by a proportional modification of the digital codes of the images. It has been reported that proportional code modification, or code modification in agreement with pre-established curves, led to not very natural image rendering.

Digital code modification according to a method in compliance with the invention certainly takes into account the exposure modification amplitude required by the user, but also the film's sensitometry relationship established from the sensitometry control. The sensitometry relationship can be taken into account in its slightest details, which is impossible with a standard sensitometry curve.

The shift to be made to each digital code of the image pixels is calculated according to the digital code initially established by the scanner, or possibly according to a difference between this code and a code taken as reference. In a particular embodiment of the method, the code shift step c) can comprise the following sub-steps for each code:
the search for an exposure value linked to the digital code by the sensitometry relationship,
the shift of this exposure value by the required exposure modification amplitude, to obtain a modified exposure value,
the search for a new digital code linked to the exposure value modified by the sensitometry relationship,
the replacement of the digital code by the new digital code.

These steps are illustrated in more detail in the rest of the description.

Step c) can also comprise the forming of a conversion table for each exposure modification required, the conversion table linking a code, shifted in compliance with the sensitometry relationship, to each digital code for a set code range. In this case, the image digital codes can be replaced directly using the conversion table.

Advantageously, the formation of the digital code conversion table can take place using the previously mentioned value table, which links the digital codes to the exposure energies.

The conversion table can be single or different for each color component, i.e. for each color layer of the photographic support. The same conversion table or same set of conversion tables can be used for many images found on the same photographic support. It can be applied automatically to all the images of a sequence or to all the images of the film.

The invention also relates, and more generally, to a shooting method comprising the capture of images on a photographic support and the forming of at least one sensitometry control on the same photographic support, and, following development of the support, digital modification of the exposure as previously described. As previously shown, such a method enables the same film type to be used in very different shooting conditions. For instance, the same film can be used in natural and artificial lighting conditions.

In this case, additional corrections can if necessary be provided to take account of the spectral sensitivity coverage of films in their colored components. Such a correction is calculated using correction matrices.

Other characteristics and advantages of the invention will appear in the following description, with reference to the figures in the appended drawings. This description is given purely as an illustration and is not limiting.

### BRIEF DESCRIPTION OF THE DRAWINGS

FIG. 1 is a diagram showing the main implementation steps of a particular embodiment of the method according to the invention.

FIG. 2 is a table representative of a sensitometry relationship that can be established during the implementation of a method according to the invention.

FIG. 3 is a curve representative of a sensitometry relationship that can be established during the implementation of a method according to the invention.

FIG. 4 is a table representative of a conversion table that can be established during the implementation of a method according to the invention.

### DETAILED DESCRIPTION OF MODES OF IMPLEMENTING THE INVENTION

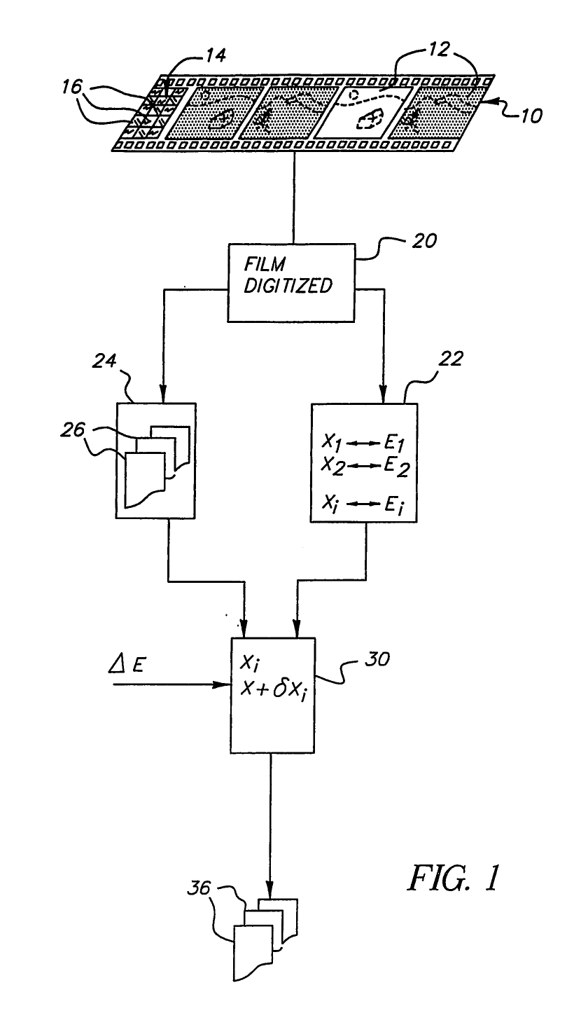

Reference 10 of FIG. 1 designates a photographic support. This is an already developed film. On the one hand, the film 10 bears images 12, resulting from photographic or motion picture shots, and, on the other hand, a sensitometry control 14.

The sensitometry control 14 is preferably formed concomitantly with the shooting. It can also be formed prior to or following the shooting. However, the fact of producing the control more or less concomitantly with the shot images, ensures comparable “aging” of the shot images and the sensitometry control. In the case of a shot made using a motion-picture camera, this camera can be equipped with an integral exposure device, enabling the sensitometry control 14 to be formed on part of the film's leader. A sensitometry control can be recorded in various parts of the film. It is formed, for instance, at the start of the film, or at the start of each sequence recorded on the same film.

The sensitometry control 14 is formed on a portion of film not having shot images. It comprises many ranges 16 subjected to various exposure energies. A calibrated exposure device enables ranges to be formed with known exposure energies, or having a known graduation, so that corresponding energies can be established by calculation. The ranges 16 can be uniform or have an exposure gradient.

The film 10 is then digitized. This step is shown by reference 20 in the figure. During this operation a digital code is linked to each image pixel. The pixel is defined here by the scanner used to perform the digitization. For capturing color images, a digital code can be linked to each pixel color component. Thus, digital codes demonstrate, for instance, the films optical density for the colors red, green and blue. The digitization is performed for the images 12 but also for the sensitometry control.

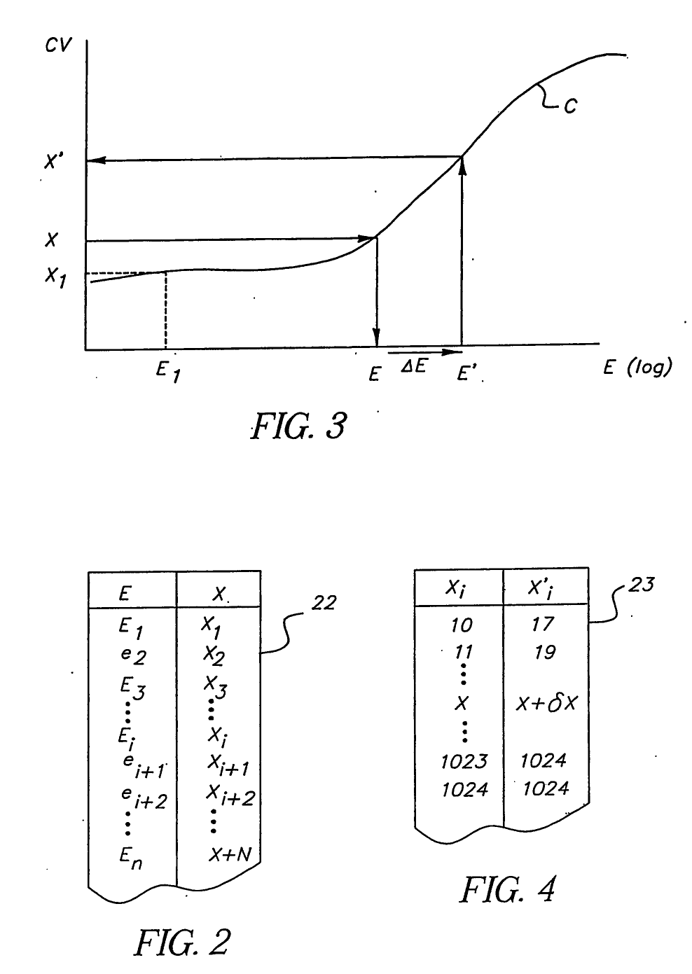

The digitization of the sensitometry control enables a table 22 to be established linking digital codes to the exposure energies of the sensitometry control. Such a table is shown summarily in FIG. 2. For a number of exposure values E corresponding to the sensitometry control ranges, the scanner delivers digital codes X. These energy values are shown in capitals E₁, Eₓ. The number of energy values, to which digital codes are linked, corresponds, for instance, to the number of ranges of the sensitometry control. When the sensitometry control has a continuous exposure gradient, the number of codes and energies taken into account depends on the number of measuring points used in the digitization. Intermediate values, obtained by interpolation can also be generated. These values are shown on FIG. 4 in lower case eₓ₊₁, eₓ₊₂.

Advantageously, the number of measured or intermediate energy values can be selected to be equal to the scanner's digital resolution so that, for a range of energy or given codes, one energy value can be linked to each digital code on a one-to-one basis.

Returning to FIG. 1, step 24 may also be noted consisting in establishing image data from digital codes. A file of image data 26 can be linked to each of the images. This file mainly contains the digital codes linked to an image's pixels.

The image data 26 and the correspondence table 24 are used in a digital code modification step 30. During this step, the exposure modification required by the user is also taken into account. It is noted ΔE and is identical for all the codes of the image, or at least a portion of the image. The exposure modification can be the same or different for the various color components; it can affect all or part of an image, it can be planed for all or part of the images, according to the user's choice.

New digital codes for all or part of an image's pixels are established based on the required exposure modification. In other words, each code x is shifted or modified by a value δx specific to it. In this way new image files 36 are obtained that correspond to images whose exposure is modified. The way in which this shift is established or calculated, is shown with reference to FIG. 3.

FIG. 3 is a graph comparable to a sensitometry curve. It represents the contents of the value table 22 of FIGS. 1 and 2. Curve C of FIG. 3 corresponds more precisely to an interpolation towards a continuum of the table values 22. The curve links the exposure energies, shown on the abscissa, to the digital codes shown on the ordinate. A comparable curve can be established if necessary for each of the color components. The numerical values of the digital codes depend on the resolution of the scanner used and its calibration. A 10-bit resolution corresponds to codes ranged between 0 and 1023, for instance.

The digital code shift principle can be described as follows. It is considered that one digital code x, for a given color component, of a given pixel, of a given image of an image file, is an input value. The second input value is the exposure modification ΔE required by the user for this color component.

Curve C of FIG. 3, or the table 22 of FIGS. 1 or 2, enables the determination, for the film in question, of what exposure E the code x corresponds to. To this exposure energy E is added (or subtracted) the correction ΔE selected by the user, in order to determine a new exposure E′ such that E′=E+ΔE. The curve C, or the table 22, then enables the determination of which new code x′ corresponds to the new energy E′. This operation can be performed and repeated for all the pixels of all the images. If the operation is performed with a table that does not contain the above-mentioned values E′ or x′ exactly, an interpolation can be performed by using one or more of the closest existing values.

According to a preferred embodiment of the invention it is also possible to establish a specific conversion table linked to the required exposure modification ΔE. To do this, all the new codes x′ corresponding to all the possible digital codes x′ are established systematically. This operation is performed independently of the contents of the image files 26. According to the previously shown principle for each digital code x a new code x′ is calculated. This corresponds to a shift δx such that x′=x+δx. The value δx is generally different for different codes, in so far as the curve C of FIG. 3 is not linear. As previously mentioned, when calculations are not performed with a continuous curve but with a table of discrete values, such as the table of FIG. 2, and the new exposure value or digital code is not given in the table, the closest existing digital exposure value or code can be used.

A conversion table is shown summarily in FIG. 4 with reference 23. Such a table can then be used as lookup table (LUT) to establish the new digital codes of all the images of the same film. The input values Xᵢ are the image digital codes and the output values X′ᵢ are the modified values.

Conversion tables can be drawn up for various exposure modifications and for various color components.

The establishment of conversion tables and their use to correct the exposure can be operations performed by software. They can also be cabled. With reference to FIG. 4, it can be seen that the table does not have to include values for all the possible codes but only for codes located in a value range corresponding to the film's maximum contrast and/or to the scanner's adjustment range.

New digital codes are recorded in new image files 36, as shown in FIG. 1. According to another possibility, the new image files 36 can be the same as the former files 26, i.e. containing the same digital codes, but by including, as metadata, the modifications to be made to the codes. For instance, the new files can contain the data of the conversion table of FIG. 4.

The files 26, containing the not-yet-modified codes, can also contain metadata. These can include, for instance, data on the exposure modifications or the exposure compensations required by a first cameraman.

### REFERENCE DOCUMENT

(1) U.S. Pat. No. 6,439,784

1. A method of digital modification of the exposure of the shot images of a photographic support comprising shot images and at least one sensitometry control, the method comprising the following steps:
a) the digitization, in substantially the same conditions, of the images and the sensitometry control, in order to link at least one digital code to the image pixels and the sensitometry control pixels,
b) the establishment of at least one sensitometry relationship from the various exposure values of the sensitometry control and the digital codes linked to the pixels corresponding to these values,
c) the shift of at least one part of the digital codes of the image pixels, each code being shifted by a value established according to a required modification amplitude of the exposure and, with respect for the sensitometry relationship.

2. A method according to claim 1, wherein the shift value of each code depends on said code.

3. A method according to claim 2, wherein the step c) comprises, for each code:
the search for an exposure value linked to the digital code by the sensitometry relationship,
the shift of this exposure value by the required exposure modification amplitude, to obtain a modified exposure value,
the search for a new digital code linked to the exposure value modified by the sensitometry relationship,
the replacement of the digital code by the new digital code.

4. A method according to claim 1, wherein the step b) comprises the formation of a value table linking a digital code to each exposure energy of the sensitometry control.

5. A method according to claim 4, wherein the formation of the value table comprises the establishment of intermediate exposure energy values by interpolation, and the linking of an exposure energy value to each digital code of a set range of codes.

6. A method according to claim 1, wherein the sensitometry control is recorded on the support more or less concomitantly with the images.

7. A method according to claim 1, wherein the step c comprises the forming of a conversion table for each required exposure modification, the conversion table linking a code shifted with respect to the sensitometry relationship to each digital code in a set code range, and, the conversion of image digital codes by using the conversion table as a lookup table.

8. A method according to claim 7, wherein a separate conversion table is established for each color layer of the photographic support.

9. A method according to claim 7, wherein the same conversion table is used for all the images found on the same photographic support.

10. A shooting method comprising the capture of images on a photographic support and the forming of at least one sensitometry control on the same photographic support, and following development of the support, digital modification of the exposure, according to the method of claim 1.
